(19) United States
(12) Patent Application Publication
(10) Pub. No.: US 2023/0345362 A1
(43) Pub. Date: Oct. 26, 2023

(54) METHOD AND DEVICE FOR LOW-POWER OPERATION-BASED COMMUNICATION IN COMMUNICATION SYSTEM SUPPORTING MULTI-LINK

(71) Applicants: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(21) Appl. No.: 17/925,561

(22) PCT Filed: May 6, 2021
(86) PCT No.: PCT/KR2021/005659

§ 371 Date: Nov. 15, 2022

(30) Foreign Application Priority Data
May 18, 2020 (KR) 10-2020-0059338

(51) Int. Cl. H04W 52/02; H04W 76/15

(52) U.S. Cl. CPC H04W 52/0216; H04W 76/15

(57) ABSTRACT

A method and a device are disclosed for low-power operation-based communication in a communication system supporting a multi-link. An operation method of a first device comprises the steps of: transitioning the operating state of a first device from a sleep state to an awake state in a first link of a multi-link; receiving a beacon frame from a second device in the first link; transmitting a first PS-Poll frame to the second device in the first link if the beacon frame indicates that a data frame to be transmitted is present in the first link; and performing a transmission/reception operation for a data frame with the second device in the first link after transmitting the first PS-Poll frame.

### CROSS-REFERENCE TO RELATED APPLICATIONS

This application is a U.S. national stage of International Application No. PCT/KR2021/005659, filed on May 6, 2021, which claims priority to Korean Patent Application No. 10-2020-0059338 filed on May 18, 2020, the entire disclosures and contents of which are incorporated by reference herein in its entirety.

### TECHNICAL FIELD

The present disclosure relates to a wireless local area network (LAN) communication technique, and more particularly, to a technique for transmitting and receiving data based on a low-power operation in a communication system supporting a multi-link.

### BACKGROUND

Recently, as the spread of mobile devices expands, a wireless local area network technology capable of providing fast wireless communication services to mobile devices is in the spotlight. As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multi-access point (AP) transmission operations, and/or efficient retransmission operations (e.g., hybrid automatic repeat request (HARQ) operations).

However, since the multi-link operation is an operation that is not defined in the existing wireless LAN standard, it may be necessary to define detailed operations according to the environment in which the multi-link operation is performed. In order to transmit data through a multi-link, a channel access method may need to be performed in each link of the multi-link. In addition, a method for supporting a low-power operation in the multi-link, a method for transmitting and receiving data based on the low-power operation, and the like may be required. In this situation, a multi-link operation for transmitting data may be required.

### SUMMARY

### Technical Problem

The present disclosure is directed to providing a method and an apparatus for transmitting and receiving data based on a low-power operation in a wireless local area network (LAN) system supporting a multi-link.

### Technical Solution

An operation method of a first device, according to a first embodiment of the present disclosure for achieving the above-described objective, may comprise: transitioning an operation state of the first device from a sleep state to an awake state in a first link of the multi-link; receiving, from a second device and in the first link, a beacon frame; transmitting, to the second device, a first power saving (PS)-Poll frame in the first link when the beacon frame indicates that a data frame to be transmitted in the first link exists; and performing a transmission/reception operation of the data frame with the second device in the first link after transmitting the first PS-Poll frame.

The beacon frame may include first information indicating one or more links in which the data frame is transmitted.

The first information may include an index of each of the one or more links or an association identifier (AID) associated with each of the one or more links.

The AID may be set in an access procedure between the first device and the second device.

The operation method may further comprise, when the first information indicates the first link and a second link, transmitting a second PS-Poll frame to the second device in the second link.

When the first information indicates the first link and a second link, the first PS-Poll frame may indicate that the first link and the second link are available.

The first PS-Poll frame may be transmitted when the first link and the second link are activated.

The first PS-Poll frame may request use of the first link, and when a Poll response frame for approving the use of the first link is received from the second device, the transmission/reception operation of the data frame may be performed.

Values of a type field and a subtype field or a value of a control frame extension field included in the Poll response frame may indicate that a response to the first PS-Poll frame is the Poll response frame.

The first link in which the first PS-Poll frame is transmitted may be a link in which a transmission operation is able to be performed first in the multi-link.

The first PS-Poll frame may include at least one of information indicating simultaneous transmit and receive (STR) capability of the first device, information indicating a number of links supportable by the first device, a first bitmap indicating available link(s) among the links supportable by the first device, a second bitmap indicating link(s) in an idle state among the links supportable by the first device, or combinations thereof.

The first PS-Poll frame may include at least one of information indicating STR capability of the first device, information indicating a number of links supportable by the first device, an AID or medium access control (MAC) address associated with each of the supportable links, or combinations thereof.

The first PS-Poll frame may be a multi-link (ML) PS-Poll frame used for a multi-link operation, and values of a type field and a subtype field, values of the type field, the subtype field, and a control frame extension field, or a value of a more data field included in the first PS-Poll frame may indicate that the first PS-Poll frame is the ML PS-Poll frame.

A first device, according to a second embodiment of the present disclosure for achieving the above-described objective, may comprise a processor and a memory storing one or more instructions executable by the processor. The one or more instructions are executed to: transition an operation state of the first device from a sleep state to an awake state in a first link of the multi-link; receive, from a second device and in the first link, a beacon frame; transmit, to the second device, a first power saving (PS)-Poll frame in the first link when the beacon frame indicates that a data frame to be transmitted in the first link exists; and perform a transmission/reception operation of the data frame with the second device in the first link after transmitting the first PS-Poll frame.

The beacon frame may include first information indicating one or more links in which the data frame is transmitted.

The first information may include an index of each of the one or more links or an association identifier (AID) associated with each of the one or more links.

The one or more instructions may be further executed to, when the first information indicates the first link and a second link, transmit a second PS-Poll frame to the second device in the second link.

When the first information indicates the first link and a second link, the first PS-Poll frame indicating that the first link and the second link are available may be transmitted when the first link and the second link are activated.

The first PS-Poll frame may request use of the first link, and when a Poll response frame for approving the use of the first link is received from the second device, the transmission/reception operation of the data frame may be performed.

The first PS-Poll frame may include at least one of information indicating STR capability of the first device, information indicating a number of links supportable by the first device, an AID or medium access control (MAC) address associated with each of the supportable links, or combinations thereof.

### Advantageous Effects

According to the present disclosure, a station (STA) supporting a multi-link can support low-power operations. The STA can inform an AP of information on a link in an idle state and/or a link in an active state. The STA operating in an awake state (e.g., active state) can transmit/receive data. The AP can transmit information indicating available links and link status information through one link. The data can be transmitted and received through the multiple links indicated by the AP. Accordingly, communication efficiency in the wireless LAN system can be improved.

### DESCRIPTION OF DRAWINGS

FIG. 1 is a block diagram illustrating a first embodiment of a communication node constituting a wireless local area network (LAN) system.

FIG. 2 is a conceptual diagram illustrating a first embodiment of multi-links configured between multi-link devices (MLDs).

FIG. 3 is a sequence chart illustrating a first embodiment of a negotiation procedure for a multi-link operation in a wireless LAN system.

FIG. 4 is a timing diagram illustrating a first embodiment of a communication method based on a low-power operation in a wireless LAN system.

FIG. 5 is a timing diagram illustrating a second embodiment of a communication method based on a low-power operation in a wireless LAN system.

FIG. 6 is a timing diagram illustrating a third embodiment of a communication method based on a low-power operation in a wireless LAN system.

FIG. 7 is a timing diagram illustrating a fourth embodiment of a communication method based on a low-power operation in a wireless LAN system.

FIG. 8 is a block diagram illustrating a first embodiment of a PS-Poll frame in a wireless LAN system supporting a multi-link.

FIG. 9 is a block diagram illustrating a first embodiment of an ML PS-Poll frame in a wireless LAN system supporting a multi-link.

FIG. 10 is a block diagram illustrating a first embodiment of a Poll response frame in a wireless LAN system supporting a multi-link.

### DETAILED DESCRIPTION

Since the present disclosure may be variously modified and may have several forms, specific embodiments are shown in the accompanying drawings and are described in the detailed description. It should be understood, however, that it is not intended to limit the present disclosure to the specific embodiments. On the contrary, the present disclosure is intended to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named as a second component without departing from the scope of the present disclosure, and the second component may also be similarly named as the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it should be understood that a further component is not disposed therebetween.

The terms used in the present disclosure are only used to describe specific embodiments and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists. However, it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings consistent with contextual meanings in the art. In this description, unless defined clearly, terms are not necessarily construed as having formal meanings.

Hereinafter, forms of the present disclosure are described in detail with reference to the accompanying drawings. In describing the disclosure, to facilitate the entire understanding of the disclosure, like numbers refer to like elements throughout the description of the figures and the repetitive description thereof has been omitted.

In the following, a wireless communication system to which embodiments according to the present disclosure are applied is described. The wireless communication system to which the embodiments according to the present disclosure are applied is not limited to the contents described below, and the embodiments according to the present disclosure can be applied to various wireless communication systems. A wireless communication system may be referred to as a ‘wireless communication network’.

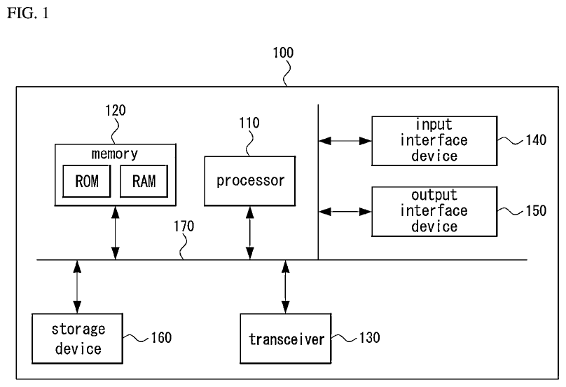

FIG. 1 is a block diagram illustrating a first embodiment of a communication node constituting a wireless local area network (LAN) system.

As shown in FIG. 1, a communication node 100 may be an access point, a station, an access point (AP) multi-link device (MLD), or a non-AP MLD. The access point may refer to an AP, and the station may refer to a STA or a non-AP STA. The operating channel width supported by the access point may be 20 megahertz (MHz), 80 MHz, 160 MHz, or the like. The operating channel width supported by the station may be 20 MHz, 80 MHz, or the like.

The communication node 100 may include at least one processor 110, a memory 120, and a plurality of transceivers 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, or the storage device 160 through a dedicated interface.

The processor 110 may execute at least one instruction stored in at least one of the memory 120 or the storage device 160. The processor 110 may refer to a central processing unit (CPU), a graphics processing unit (GPU), or a dedicated processor on which the methods according to the embodiments of the present disclosure are performed. Each of the memory 120 and the storage device 160 may be configured as at least one of a volatile storage medium or a nonvolatile storage medium. For example, the memory 120 may be configured with at least one of a read only memory (ROM) or a random access memory (RAM).

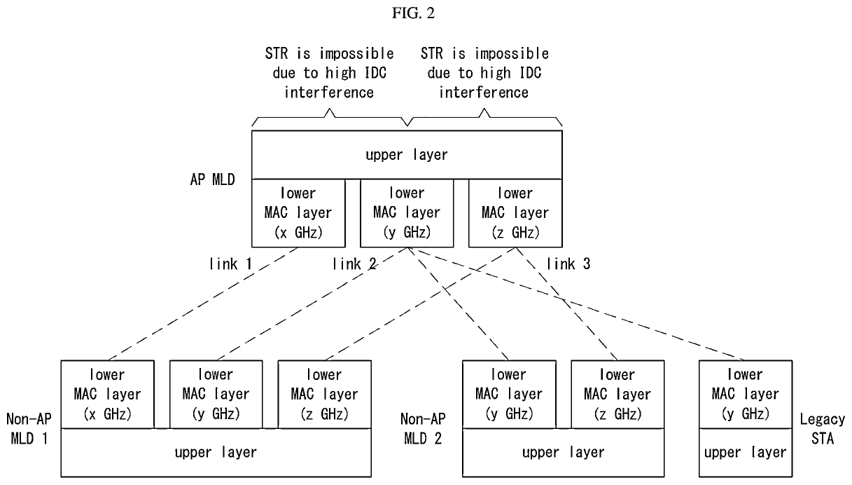

FIG. 2 is a conceptual diagram illustrating a first embodiment of multi-links configured between MLDs.

As shown in FIG. 2, an MLD may have one medium access control (MAC) address. In embodiments, the MLD may mean an AP MLD and/or a non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) (STA(s)) affiliated with the non-AP MLD may have different MAC addresses. Each of the APs having different MAC addresses may be in charge of each link among multiple links supported by the AP MLD and may perform a role of an independent AP.

Each of the STAs having different MAC addresses may be in charge of each link among multiple links supported by the non-AP MLD and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links (i.e., multi-link) by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band and may perform communications using a 160 MHz bandwidth according to a channel expansion scheme in a 5 GHz band. The MLD may perform communications using a 160 MHz bandwidth in the 5 GHz band and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, the respective links may be referred to as a link 1, a link 2, and a link 3. A link number may be set by the AP, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between the link 1 and the link 2 in the frequency domain) is sufficient, the MLD may perform an STR operation. For example, the MLD may transmit a physical layer convergence procedure (PLCP) protocol data unit (PPDU) 1 using the link 1 among multiple links and may receive a PPDU 2 using the link 2 among multiple links. On the other hand, if the MLD performs the STR operation when the band separation between multiple links is insufficient, in-device coexistence (IDC) interference, which is interference between the multiple links, may occur. Therefore, when the band separation between multiple links is not sufficient, the MLD may not be able to perform the STR operation.

For example, a multi-link including a link 1, a link 2, and a link 3 may be configured between the AP MLD and the non-AP MLD. If the band separation between the link 1 and the link 3 is sufficient, the AP MLD may perform an STR operation using the link 1 and the link 3. In other words, the AP MLD may transmit a frame using the link 1 and may receive a frame using the link 3. If the band separation between the link 1 and the link 2 is not sufficient, the AP MLD may not be able to perform an STR operation using the link 1 and the link 2. If a band separation between the link 2 and the link 3 is not sufficient, the AP MLD may not be able to perform an STR operation using the link 2 and the link 3.

In a wireless LAN system, a negotiation procedure for a multi-link operation may be performed in an access procedure between a STA and an AP.

A device (e.g., AP or STA) supporting a multi-link may be referred to as a multi-link device (MLD). An AP supporting a multi-link may be referred to as an AP MLD, and a STA supporting a multi-link may be referred to as a non-AP MLD or STA MLD. The AP MLD may have a physical address (e.g., MAC address) for each link. The AP MLD may be implemented as if an AP in charge of each link exists separately. A plurality of APs may be managed within one AP MLD. Accordingly, coordination between the plurality of APs belonging to the same AP MLD may be possible. The STA MLD may have a physical address (e.g., MAC address) for each link. The STA MLD may be implemented as if a STA in charge of each link exists separately. A plurality of STAs may be managed within one STA MLD. Accordingly, coordination between the plurality of STAs belonging to the same STA MLD may be possible.

For example, an AP1 of the AP MLD and a STA1 of the STA MLD may each be in charge of a first link and may communicate using the first link. An AP2 of the AP MLD and a STA2 of the STA MLD may each be in charge of a second link and may communicate using the second link. The STA2 may receive state change information for the first link in the second link. In this case, the STA MLD may collect information (e.g., state change information) received from each link and may control operations performed by the STA1 based on the collected information.

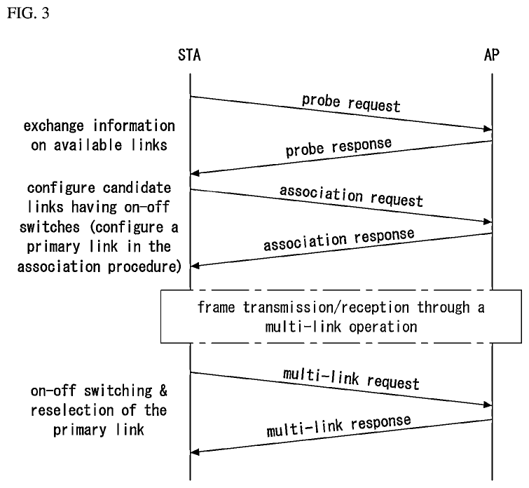

FIG. 3 is a sequence chart illustrating a first embodiment of a negotiation procedure for a multi-link operation in a wireless LAN system.

As shown in FIG. 3 an access procedure between a STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step and may perform the association step with the selected AP. In other words, the STA may transmit an association request frame to the selected AP and may complete the association with the AP by receiving an association response frame that is a response to the association request frame from the selected AP.

A multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between a STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP. Also, information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

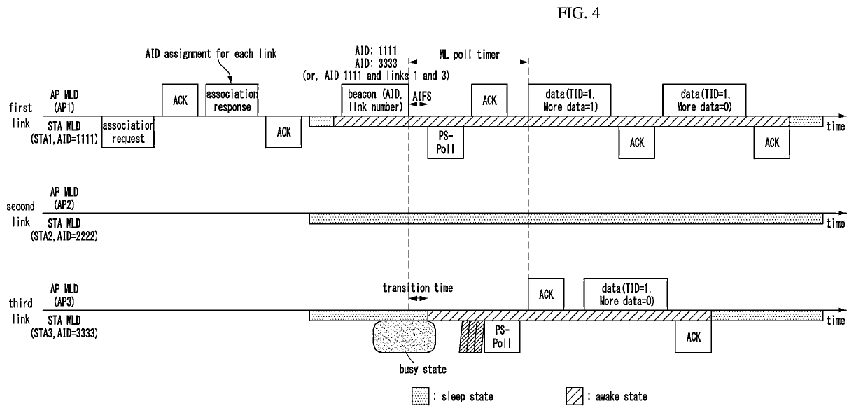

FIG. 4 is a timing diagram illustrating a first embodiment of a communication method based on a low-power operation in a wireless LAN system.

As shown in FIG. 4, a communication node may transmit/receive frames using a plurality of links (e.g., first link, second link, and third link). In embodiments, the communication node may be an AP MLD, an AP affiliated with an AP MLD, a STA MLD (e.g., non-AP MLD), or a STA affiliated with a STA MLD. The device (e.g., AP MLD and/or non-AP MLD) may use different MAC addresses for the respective links. Although the device is one communication node, the device may act like a different communication node in each of the links. For example, a first AP affiliated with the AP MLD may operate in the first link, a second AP affiliated with the AP MLD may operate in the second link, and a third AP affiliated with the AP MLD may operate in the third link. A first STA affiliated with the STA MLD may operate in the first link, a second STA affiliated with the STA MLD may operate in the second link, and a third STA affiliated with the STA MLD may operate in the third link.

The STA MLD (e.g., first STA) may perform an access procedure with the AP MLD (e.g., first AP) in the first link. By exchanging an association request frame and an association response frame in the access procedure, basic function(s) between the STA MLD and the AP MLD may be agreed upon (e.g., negotiated). In this case, parameter(s) for low-power operations may be negotiated. The association request frame may include a listen interval field, and the listen interval field may indicate a transmission interval of a beacon frame (e.g., beacon frame including a traffic indication map (TIM)). A period indicated by the listen interval field may refer to a period in which a reception operation is performed for a low-power operation. A period other than the period indicated by the listen interval field may refer to a period in which a reception operation is not performed. The listen interval field set to 0 may indicate that a low-power operation is not performed.

The low-power operation may be an operation of receiving a TIM indicating whether a buffered unit (BU) exists in a link (e.g., first link) where the association request frame is transmitted/received. When desiring to receive the TIM in another link, information indicating the corresponding link may be included in the association request frame. The AP MLD may receive the association request frame from the STA MLD in the first link and may identify information element(s) (e.g., listen interval field) included in the association request frame. The AP MLD may transmit an acknowledgment (ACK) frame for the association request frame to the STA MLD. Alternatively, transmission of the ACK frame for the association request frame may be omitted.

The AP MLD may set an association identifier (AID) to be used by the STA. The AID may be set for each link. The AP MLD may transmit an association response frame including the AID of each of the links. The AID may be used to indicate (e.g., identify) a communication node (e.g., STA) in the case(s) below.
Case 1: When the AP allocates a resource to a communication node (e.g., STA) using a trigger frame
Case 2: When the AP uses a TIM to indicate a communication node to receive a BU
Case 3: When the communication node transmits a power saving (PS)-Poll frame to receive a BU indicated by a TIM

For the STA MLD supporting a multi-link, a distinct AID may be assigned to each of the links. ‘AID=1111’ may be assigned to the STA1 of the STA MLD, ‘AID=2222’ may be assigned to the STA2 of the STA MLD, and ‘AID=3333’ may be assigned to the STA3 of the STA MLD. The STA1 may receive the association response frame from the AP1 in the first link and may identify information element(s) (e.g., AID for each link) included in the association response frame. The STA1 may transmit an ACK frame for the association response frame to the AP1 in the first link. Alternatively, the transmission operation of the ACK frame for the association response frame may be omitted.

Alternatively, one AID may be assigned to the STA MLD supporting the multi-link, and each of the links (e.g., STAs affiliated with the STA MLD) may be identified by link identification information (e.g., link identifiers or traffic IDs (TIDs)). The AP MLD and the STA MLD may perform a negotiation procedure of mapping links to receive to traffic IDs (TIDs) of data frames to be received (i.e., TID-to-link mapping). After the negotiation procedure is performed, the communication node (e.g., AP MLD, STA MLD, AP, STA) may determine the links to receive based on the mapping relationship between the TIDs and the links when the TIDs of the data frames to be received are known.

When the access procedure is terminated, the STA MLD may perform a low-power operation. For example, the STA1 may perform a low-power operation in the first link (e.g., link where the access procedure has been performed), and the STA2 and/or STA3 may perform low-power operations in other links (e.g., the second link and/or the third link) as well as the first link. The STA1 may operate in a sleep state in the first link and may transition to an awake state at a time negotiated in the access procedure. In other words, an operation state of the STA1 may be transitioned from the sleep state to the awake state. In embodiments, the sleep state may be referred to as a sleep mode, a doze mode, a doze state, an idle mode, or an idle state, and the awake state may be referred to as an awake mode, an active mode, an active state, a wakeup mode, or a wakeup state.

The STA MLD (e.g., STA1) operating in the awake state may perform a reception operation of a beacon frame and may identify a TIM included in the beacon frame. When the TIM indicates that a BU (e.g., data) for the STA MLD does not exist, the operation state of the STA MLD may transition from the awake state to the sleep state. In other words, the STA MLD may operate in the sleep state. When the TIM indicates that a BU for the STA MLD exists, the STA1 may operate in the awake state without transitioning to the sleep state. In other words, the operation state of the STA1 may be maintained in the awake state. The STA1 operating in the awake state may transmit a PS-Poll frame to the AP1 in the first link. The PS-Poll frame may indicate that the STA1 operates in the awake state. The AP1 may receive the PS-Poll frame from the STA1 in the first link. When the PS-Poll frame of the STA1 is received, the AP1 may determine that the STA1 operates in the awake state. The AP1 may transmit an ACK frame for the PS-Poll frame to the STA1.

In order to transmit data frames using the multi-link, the AP MLD (e.g., AP1) supporting the multi-link may inform the STA MLD having an AID assigned by the AP MLD of link identification information (e.g., link number or TID) of a link in which the corresponding STA MLD is to receive a data frame. When the link identification information is the TID, the STA MLD may identify the link (e.g., link number) mapped to the link identification information (i.e., TID) obtained from the AP MLD based on the mapping relationship between the TIDs and the links, which is preconfigured by the negotiation procedure. The link identification information may be included in the beacon frame. Alternatively, the AP MLD may inform the link identification information through a separate frame (e.g., TIM frame). For example, the link identification information included in the beacon frame or the separate frame may indicate the first link and the third link. Alternatively, since different AIDs are assigned for the respective links, the AP MLD may set the AID of the STA operating in the link to transmit the data frame by using the TIM. For example, the TIM may indicate that BUs (e.g., data) of the STA1 having ‘AID=1111’ and the STA3 having ‘AID=3333’ exist.

The STA1 may determine that the data frames are to be transmitted in the first link and the third link based on the beacon frame (e.g., TIM included in the beacon frame) and/or the separate frame received from the APE The STA1 may inform the STA MLD of the link identification information (e.g., TIDs and/or link identifiers) indicated by the beacon frame and/or separate frame and/or the AIDs (e.g., 1111 and 3333) indicated by the TIM included in the beacon frame. The STA MLD may determine that the data frames are to be transmitted in the first link and the third link from the APE Alternatively, the STA MLD may determine that the data frames for the STA1 and the STA3 are to be transmitted based on the AIDs received from the APE In this case, the STA MLD may control the STA1 and the STA3 to transmit PS-Poll frames to the AP MLD. In order to transmit the PS-Poll frames, the operation states of the STA1 and the STA3 should be the awake state. Since the STA1 is already in the awake state, it is necessary to transition the STA3 to the awake state.

A transition time may be required to transition the operation state of the STA3 from the sleep state to the awake state. The transition time may be referred to as ‘state transition time’, ‘transition delay time’, or ‘turn-on time’. The AP MLD may know in advance the transition time for the STA (e.g., STA3). The AP MLD may transmit the data frame after the transition time elapses.

Specifically, the transition time may be divided into an awake transition time and a NAV synchronization (i.e., NAVSyncDelay) time. The awake transition time may be a time required for transitioning from the sleep state to the awake state. The awake state may refer to a state in which a normal reception operation including channel sensing can be performed. When a STA fails to read a header of a frame transmitted by another STA while the STA is in the sleep state and thus performs transmission while a NAV is not normally set, since it may interfere with the frame being transmitted by another STA and cause an error, the NAV synchronization (i.e., NAVSyncDelay) time may be a time of waiting without transmitting. If the STA can normally set a NAV by receiving a frame transmitted by another STA after waiting for a preset time, the NAV synchronization time may be changed to a NAV end time. Alternatively, if a normal NAV is set within the NAV synchronization time, the NAV synchronization time may end and only the NAV may be operated.

The transition time may start from a transmission end time (or reception end time) of the frame (e.g., beacon frame) including the link identification information (e.g., TIDs and/or link identifiers) of the links in which the BUs are to be received. The STA1 may transmit the PS-Poll frame to the AP1 by performing a channel access procedure in the first link. When the PS-Poll frame is received from the STA1, the AP1 may transmit an ACK frame for the PS-Poll frame to the STA1. Thereafter, a data frame transmission/reception procedure between the AP1 and the STA1 may be performed. The STA3 may transmit the PS-Poll frame to the AP3 by performing a channel access procedure in the third link. When the PS-Poll frame is received from the STA3, the AP3 may transmit an ACK frame for the PS-Poll frame to the STA3. Thereafter, a data frame transmission/reception procedure between the AP3 and the STA3 may be performed. The PS-Poll frame may be independently transmitted by each of the STA1 and the STA3. When a synchronized transmission scheme is used in the multi-link, a transmission start time and a transmission end time of the data frame in the first link may be configured to be the same as a transmission start time and a transmission end time of the data frame in the third link, respectively.

The STA MLD may transmit the PS-Poll frames in all of the links indicated by the frame (e.g., beacon frame (e.g., TIM included in the beacon frame)) including the link identification information (e.g., TIMs and/or link identifiers) of the links in which the BUs are to be received. Even when a link in which the PS-Poll frame is not received is a link in which the indicated BU is to be received, the AP MLD may determine that the corresponding link is an unavailable link and may not use the unavailable link for data frame transmission. The PS-Poll frames may be received in a plurality of links indicated by the frame including the link identification information of link(s) in which the BUs are to be received. In this case, the AP MLD may start a transmission operation of the data frame in the link in which the PS-Poll frame is received first among the plurality of links. The AP (e.g., AP1) may set a multi-link (ML) poll timer to perform transmission operations in all the links. The ML poll timer may start when the TIM is transmitted and/or when the first PS-Poll frame is received. The AP (e.g., AP1) may transmit the data frame(s) through the link(s) in which the PS-Poll frame(s) are received until the ML Poll timer expires. The ML poll timer may be set to a time including the transition time. The ML poll timer may be set to a time during which the STA can transmit the PS-Poll frame by performing a channel access operation (e.g., backoff operation) after the transition time elapses. The ML poll Timer may be used to transmit the data frames in the synchronized transmission scheme. The AP MLD may wait until the ML poll timer expires to transmit the data frame(s) in the synchronized transmission scheme only in the link(s) in which the PS-Poll frame(s) have been transmitted. In the links in which the data frames are to be transmitted, the AP MLD may perform a backoff operation in advance until the ML poll timer expires. When the backoff operation is successful and thus a backoff counter becomes 0, the AP MLD may wait in the state in which the backoff counter is 0 and may immediately transmit the data frame if a channel is in an idle state at the moment the ML poll timer expires in the link(s) in which the PS-Poll frame(s) have been received among the links where the backoff operation is successful. The AP MLD may wait in the state in which the backoff counter is 0 in a plurality of links in which the backoff operation has been performed.

The AP MLD may inform the STA MLD of the ML poll timer. The ML poll timer may be set in an access procedure between the AP MLD and the STA MLD (e.g., procedure for transmitting and receiving the association request frame and the association response frame). Among the STAs, STA(s) that have not transmitted the PS-Poll frame before expiration of the ML poll timer may transition to the sleep state to perform a low-power operation. In other words, the operation state(s) of the corresponding STA(s) may be transitioned from the awake state to the sleep state after the ML poll timer expires. If a link is occupied by another communication node, the PS-Poll frame may not be transmitted in the link. A ‘failure to transmit the PS-Poll frame’ may mean that the link in which the PS-Poll frame is not transmitted is highly congested.

Among the STAs of the STA MLD, STAs transitioning to the awake state by receiving information on the link in which a BU is to be received may transmit frames after the transition time. The transition time may be divided into the aforementioned awake transition time and NAV synchronization (i.e., NAVSyncDelay) time. The AP MLD may transmit a trigger frame (TF) during the NAV synchronization (i.e., NAVSyncDelay) time so that the STA MLD may transmit the PS-Poll frame. The TF may be transmitted after the awake transition time of the STA elapses. The STA may transmit the PS-Poll frame in response to the TF. The AP MLD may transmit ACK(s) to the STA(s) that have transmitted the PS-Poll frame. Thereafter, the AP MLD may transmit data frame(s) in the link(s) that the corresponding STA(s) are responsible for. When transmitting the TF, the AP MLD may configure a transmit opportunity (TXOP) including a time required for receiving the PS-Poll frame as well as a time required for transmitting the data frame. The total TXOP may be (transmission time of TF+SIFS+transmission time of PS-Poll frame+SIFS+reception time of ACK+SIFS+transmission time of data frame+SIFS+reception time of BA). The ACK for the PS-Poll frame may be transmitted together with the data frame in form of an A-MPDU. In this case, the total TXOP may be (transmission time of TF+SIFS+reception time of PS-Poll frame+SIFS+transmission time of A-MPDU (i.e., ACK+data frame)+SIFS+reception time of BA).

The AP MLD may transmit the data frame(s) in the link(s) in which the PS-Poll frame has been received. A MAC header of the data frame may include a ‘more data’ field. For example, when data to be transmitted remains after transmission of the data frame in a specific link (e.g., first link), the more data field included in the MAC header of the data frame may be set to 1. When the more data field is set to 1, the STA may continue to perform the data frame reception operation without transitioning to the sleep state. When there is no data to be transmitted after transmission of the data frame in the specific link (e.g., when transmission of the current data frame is the last transmission), the more data field included in the MAC header of the data frame may be set to 0. When the more data field is set to 0, the STA may transition to the sleep state. In the first link, a more data field of the first data frame may be set to 1, and a more data field of the second data frame may be set to 0. In the third link, a more data field of the data frame may be set to 0.

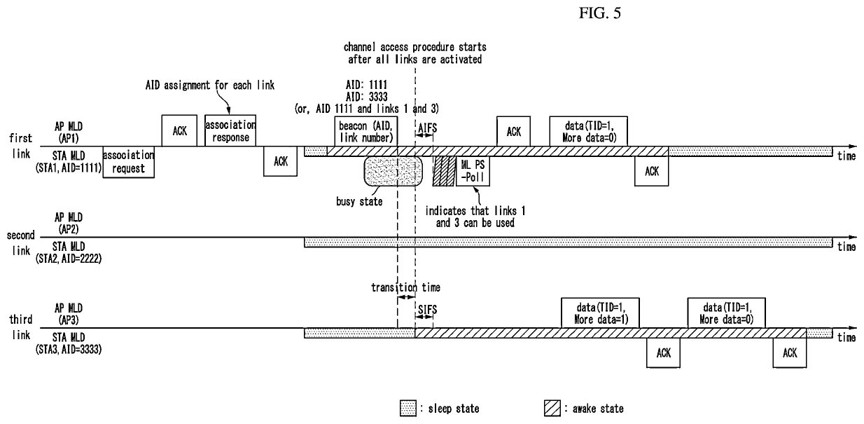

FIG. 5 is a timing diagram illustrating a second embodiment of a communication method based on a low-power operation in a wireless LAN system.

As shown in FIG. 5, a communication node may transmit/receive frames using a plurality of links (e.g., first link, second link, and third link). In embodiments, the communication node may be an AP MLD, an AP affiliated with an AP MLD, a STA MLD (e.g., non-AP MLD), or a STA affiliated with a STA MLD. The device (e.g., AP MLD and/or non-AP MLD) may use different MAC addresses for the respective links. Although the device is one communication node, the device may act like a different communication node in each of the links. For example, a first AP affiliated with the AP MLD may operate in the first link, a second AP affiliated with the AP MLD may operate in the second link, and a third AP affiliated with the AP MLD may operate in the third link. A first STA affiliated with the STA MLD may operate in the first link, a second STA affiliated with the STA MLD may operate in the second link, and a third STA affiliated with the STA MLD may operate in the third link.

The STA MLD (e.g., first STA) may perform an access procedure with the AP MLD (e.g., first AP) in the first link. By exchanging an association request frame and an association response frame in the access procedure, basic function(s) between the STA MLD and the AP MLD may be agreed upon (e.g., negotiated). In this case, parameter(s) for low-power operations may be negotiated. The association request frame may include a listen interval field, and the listen interval field may indicate a transmission interval of a beacon frame (e.g., beacon frame including a traffic indication map (TIM)). A period indicated by the listen interval field may refer to a period in which a reception operation is performed for a low-power operation. A period other than the period indicated by the listen interval field may refer to a period in which a reception operation is not performed. The listen interval field set to 0 may indicate that a low-power operation is not performed.

The low-power operation may be an operation of receiving a TIM indicating whether a BU exists in a link (e.g., first link) where the association request frame is transmitted/received. When desiring to receive the TIM in another link, information indicating the corresponding link may be included in the association request frame. The AP MLD may receive the association request frame from the STA MLD in the first link and may identify information element(s) (e.g., listen interval field) included in the association request frame. The AP MLD may transmit an acknowledgment (ACK) frame for the association request frame to the STA MLD. Alternatively, transmission of the ACK frame for the association request frame may be omitted.

The AP MLD may set an AID to be used by the STA. The AID may be set for each link. The AP MLD may transmit an association response frame including the AID of each of the links. The AID may be used to indicate (e.g., identify) a communication node (e.g., STA) in the case(s) below.
Case 1: When the AP allocates a resource to a communication node (e.g., STA) using a trigger frame
Case 2: When the AP uses a TIM to indicate a communication node to receive a BU
Case 3: When the communication node transmits a PS-Poll frame to receive a BU indicated by a TIM

For the STA MLD supporting a multi-link, a distinct AID may be assigned to each of the links. ‘AID=1111’ may be assigned to the STA1 of the STA MLD, ‘AID=2222’ may be assigned to the STA2 of the STA MLD, and ‘AID=3333’ may be assigned to the STA3 of the STA MLD. The STA1 may receive the association response frame from the AP1 in the first link and may identify information element(s) (e.g., AID for each link) included in the association response frame. The STA1 may transmit an ACK frame for the association response frame to the AP1 in the first link. Alternatively, the transmission operation of the ACK frame for the association response frame may be omitted.

Alternatively, one AID may be assigned to the STA MLD supporting the multi-link, and each of the links (e.g., STAs affiliated with the STA MLD) may be identified by link identification information (e.g., link identifiers or TIDs). The AP MLD and the STA MLD may perform a negotiation procedure of mapping links to receive to TIDs of data frames to be received (i.e., TID-to-link mapping). After the negotiation procedure is performed, the communication node (e.g., AP MLD, STA MLD, AP, STA) may determine the links to receive based on the mapping relationship between the TIDs and the links when the TIDs of the data frames to be received are known.

When the access procedure is terminated, the STA MLD may perform a low-power operation. For example, the STA1 may perform a low-power operation in the first link (e.g., link where the access procedure has been performed), and the STA2 and/or STA3 may perform low-power operations in other links (e.g., the second link and/or the third link) as well as the first link. The STA1 may operate in the sleep state in the first link and may transition to the awake state at a time negotiated in the access procedure.

The STA MLD (e.g., STA1) operating in the awake state may perform a reception operation of a beacon frame and may identify a TIM included in the beacon frame. When the TIM indicates that a BU (e.g., data) for the STA MLD does not exist, the operation state of the STA MLD may transition from the awake state to the sleep state. In other words, the STA MLD may operate in the sleep state. When the TIM indicates that a BU for the STA MLD exists, the STA1 may operate in the awake state without transitioning to the sleep state. In other words, the operation state of the STA1 may be maintained in the awake state. The STA1 operating in the awake state may transmit a multi-link (ML) PS-Poll frame to the AP1 in the first link. The ML PS-Poll frame may indicate that the STA1 operates in the awake state. The AP1 may receive the ML PS-Poll frame from the STA1 in the first link. When the ML PS-Poll frame of the STA1 is received, the AP1 may determine that the STA1 operates in the awake state. The AP1 may transmit an ACK frame for the ML PS-Poll frame to the STA1.

In order to transmit data frames using the multi-link, the AP MLD (e.g., AP1) supporting the multi-link may inform the STA MLD having an AID assigned by the AP MLD of link identification information (e.g., link number or TID) of a link in which the corresponding STA MLD is to receive a data frame. When the link identification information is the TID, the STA MLD may identify the link (e.g., link number) mapped to the link identification information (i.e., TID) obtained from the AP MLD based on the mapping relationship between the TIDs and the links, which is preconfigured by the negotiation procedure. The link identification information may be included in the beacon frame. Alternatively, the AP MLD may inform the link identification information through a separate frame (e.g., TIM frame). For example, the link identification information included in the beacon frame or the separate frame may indicate the first link and the third link. Alternatively, since different AIDs are assigned for the respective links, the AP MLD may set the AID of the STA operating in the link to transmit the data frame by using the TIM. For example, the TIM may indicate that BUs (e.g., data) of the STA1 having ‘AID=1111’ and the STA3 having ‘AID=3333’ exist.

The STA1 may determine that the data frames are to be transmitted in the first link and the third link based on the beacon frame (e.g., TIM included in the beacon frame) and/or the separate frame received from the APE The STA1 may inform the STA MLD of the link identification information (e.g., TIDs and/or link identifiers) indicated by the beacon frame and/or separate frame and/or the AIDs (e.g., 1111 and 3333) indicated by the TIM included in the beacon frame. The STA MLD may determine that the data frames are to be transmitted in the first link and the third link from the APE Alternatively, the STA MLD may determine that the data frames for the STA1 and the STA3 are to be transmitted based on the AIDs received from the AP1.

The STA1 operating in the awake state may perform a channel access procedure to transmit the ML PS-Poll frame in the first link. A channel state of another link (e.g., the third link) indicated by the frame (e.g., beacon frame) including the link identification information (e.g., TIDs and/or link identifiers) of links in which BUs are to be received may be sensed for a preset time (e.g., short interframe space (SIFS), PIFS, or NAV synchronization (NAVSyncDelay) time) while the channel access procedure is being performed in the first link. The preset time may start when the operation state of the STA3 operating in the third link is transitioned from the sleep state to the awake state. The ML PS-Poll frame transmitted in the first link may include information indicating whether the STA MLD can receive a data frame in another link, information indicating the state (e.g., operation state) of the STA in each link, and/or information indicating a sensing result for a preset time in another link. The ML PS-Poll frame transmitted in the first link may be transmitted after the above-described sensing for the preset time to include state information of another link. A sensing result for the preset time for a link in which the STA MLD does not want to receive a data frame, among the links indicated as the links in which the STA MLD is to receive data frames, may be configured to indicate a busy state. The reason for designating the link in which the STA MLD does not want to receive a data frame is that the STA MLD may want to receive data frame(s) only in one link or a small number of links to prevent power consumption. Alternatively, the link in which the STA does not want to receive a data frame may be designated also when the STA fails to transition to the awake state.

When the STA associated with the AID is the STA MLD, the ML PS-Poll frame may be configured by interpreting a receiver address (RA) and/or a transmitter address (TA) of the existing PS-Poll frame into another form. An additional format of the ML PS-Poll frame may be configured. When the ML PS-Poll frame is configured by interpreting the RA and/or TA of the PS-Poll frame in another form, an available link bitmap may indicate link(s) in an active state, and a link status bitmap may indicate a sensing result for a preset time (e.g., SIFS, PIFS, or NAV synchronization time). When the additional format of the ML PS-Poll frame is used, the link(s) in the active state may be indicated by the AID(s) and/or the MAC address(s) of the STA(s), and the link status bitmap may indicate a sensing result for the preset time.

The ML PS-Poll frame may be transmitted in a link capable of transmitting the ML PS-Poll frame first among multiple links. For example, when the first link and the third link are indicated by the link identification information (i.e., beacon frame or separate frame) of the links to be received and when the ML PS-Poll frame can be transmitted in the third link in the idle state after an arbitration interframe space (AIFS) elapses, the ML PS-Poll frame may be transmitted in the third link. When the ML PS-Poll frame is transmitted in the link capable of transmitting the ML PS-Poll frame first among multiple links, a probability that the state(s) of other link(s) are the busy state may be high.

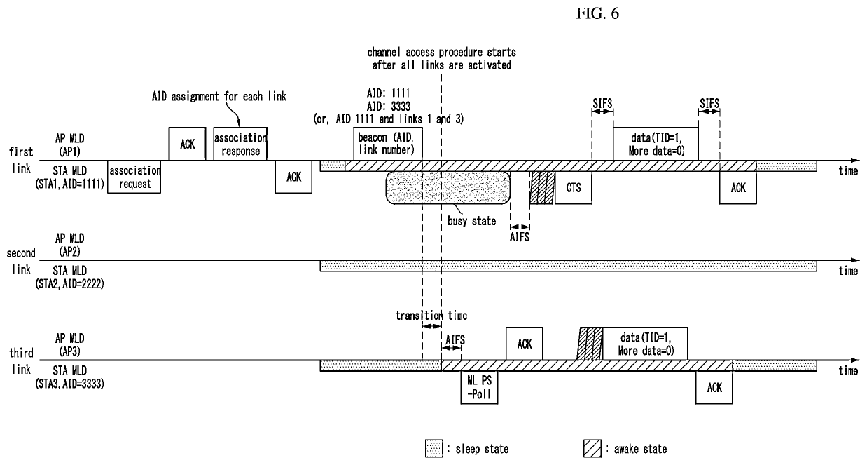

FIG. 6 is a timing diagram illustrating a third embodiment of a communication method based on a low-power operation in a wireless LAN system.

As shown in FIG. 6, a communication node may transmit/receive frames using a plurality of links (e.g., first link, second link, and third link). In embodiments, the communication node may be an AP MLD, an AP affiliated with an AP MLD, a STA MLD (e.g., non-AP MLD), or a STA affiliated with a STA MLD. The device (e.g., AP MLD and/or non-AP MLD) may use different MAC addresses for the respective links. Although the device is one communication node, the device may act like a different communication node in each of the links. For example, a first AP affiliated with the AP MLD may operate in the first link, a second AP affiliated with the AP MLD may operate in the second link, and a third AP affiliated with the AP MLD may operate in the third link. A first STA affiliated with the STA MLD may operate in the first link, a second STA affiliated with the STA MLD may operate in the second link, and a third STA affiliated with the STA MLD may operate in the third link.

The STA MLD (e.g., first STA) may perform an access procedure with the AP MLD (e.g., first AP) in the first link. By exchanging an association request frame and an association response frame in the access procedure, basic function(s) between the STA MLD and the AP MLD may be agreed upon (e.g., negotiated). In this case, parameter(s) for low-power operations may be negotiated. The association request frame may include a listen interval field, and the listen interval field may indicate a transmission interval of a beacon frame (e.g., beacon frame including a TIM). A period indicated by the listen interval field may refer to a period in which a reception operation is performed for a low-power operation. A period other than the period indicated by the listen interval field may refer to a period in which a reception operation is not performed. The listen interval field set to 0 may indicate that a low-power operation is not performed.

The low-power operation may be an operation of receiving a TIM indicating whether a BU exists in a link (e.g., first link) where the association request frame is transmitted/received. When desiring to receive the TIM in another link, information indicating the corresponding link may be included in the association request frame. The AP MLD may receive the association request frame from the STA MLD in the first link and may identify information element(s) (e.g., listen interval field) included in the association request frame. The AP MLD may transmit an acknowledgment (ACK) frame for the association request frame to the STA MLD. Alternatively, transmission of the ACK frame for the association request frame may be omitted.

The AP MLD may set an AID to be used by the STA. The AID may be set for each link. The AP MLD may transmit an association response frame including the AID of each of the links. The AID may be used to indicate (e.g., identify) a communication node (e.g., STA) in the case(s) below.
Case 1: When the AP allocates a resource to a communication node (e.g., STA) using a trigger frame
Case 2: When the AP uses a TIM to indicate a communication node to receive a BU
Case 3: When the communication node transmits a PS-Poll frame to receive a BU indicated by a TIM

For the STA MLD supporting a multi-link, a distinct AID may be assigned to each of the links. ‘AID=1111’ may be assigned to the STA1 of the STA MLD, ‘AID=2222’ may be assigned to the STA2 of the STA MLD, and ‘AID=3333’ may be assigned to the STA3 of the STA MLD. The STA1 may receive the association response frame from the AP1 in the first link and may identify information element(s) (e.g., AID for each link) included in the association response frame. The STA1 may transmit an ACK frame for the association response frame to the AP1 in the first link. Alternatively, the transmission operation of the ACK frame for the association response frame may be omitted.

Alternatively, one AID may be assigned to the STA MLD supporting the multi-link, and each of the links (e.g., STAs affiliated with the STA MLD) may be identified by link identification information (e.g., link identifiers or traffic IDs (TIDs)). The AP MLD and the STA MLD may perform a negotiation procedure of mapping links to receive to traffic IDs (TIDs) of data frames to be received (i.e., TID-to-link mapping). After the negotiation procedure is performed, the communication node (e.g., AP MLD, STA MLD, AP, STA) may determine the links to receive based on the mapping relationship between the TIDs and the links when the TIDs of the data frames to be received are known.

When the access procedure is terminated, the STA MLD may perform a low-power operation. For example, the STA1 may perform a low-power operation in the first link (e.g., link where the access procedure has been performed), and the STA2 and/or STA3 may perform low-power operations in other links (e.g., the second link and/or the third link) as well as the first link. The STA1 may operate in the sleep state in the first link and may transition to the awake state at a time negotiated in the access procedure.

The STA MLD (e.g., STA1) operating in the awake state may perform a reception operation of a beacon frame and may identify a TIM included in the beacon frame. When the TIM indicates that a BU (e.g., data) for the STA MLD does not exist, the operation state of the STA MLD may transition from the awake state to the sleep state. In other words, the STA MLD may operate in the sleep state. When the TIM indicates that a BU for the STA MLD exists, the STA1 may operate in the awake state without transitioning to the sleep state. In other words, the operation state of the STA1 may be maintained in the awake state.

In order to transmit data frames using the multi-link, the AP MLD (e.g., AP1) supporting the multi-link may inform the STA MLD having an AID assigned by the AP MLD of link identification information (e.g., link number or TID) of a link in which the corresponding STA MLD is to receive a data frame. When the link identification information is the TID, the STA MLD may identify the link (e.g., link number) mapped to the link identification information (i.e., TID) obtained from the AP MLD based on the mapping relationship between the TIDs and the links, which is preconfigured by the negotiation procedure. The link identification information may be included in the beacon frame. Alternatively, the AP MLD may inform the link identification information through a separate frame (e.g., TIM frame). For example, the link identification information included in the beacon frame or the separate frame may indicate the first link and the third link. Alternatively, since different AIDs are assigned for the respective links, the AP MLD may set the AID of the STA operating in the link to transmit the data frame by using the TIM. For example, the TIM may indicate that BUs (e.g., data) of the STA1 having ‘AID=1111’ and the STA3 having ‘AID=3333’ exist.

The STA1 may determine that the data frames are to be transmitted in the first link and the third link based on the beacon frame (e.g., TIM included in the beacon frame) and/or the separate frame received from the APE The STA1 may inform the STA MLD of the link identification information (e.g., TIDs and/or link identifiers) indicated by the beacon frame and/or separate frame and/or the AIDs (e.g., 1111 and 3333) indicated by the TIM included in the beacon frame. The STA MLD may determine that the data frames are to be transmitted in the first link and the third link from the APE Alternatively, the STA MLD may determine that the data frames for the STA1 and the STA3 are to be transmitted based on the AIDs received from the AP1.

The STA1 operating in the awake state may perform a channel access procedure to transmit the ML PS-Poll frame in the first link. A channel state of another link (e.g., the third link) indicated by the frame (e.g., beacon frame) including the link identification information (e.g., TIDs and/or link identifiers) of links in which BUs are to be received may be sensed for a preset time (e.g., SIFS, PIFS, or NAV synchronization (NAVSyncDelay) time) while the channel access procedure is being performed in the first link. The preset time may start when the operation state of the STA3 operating in the third link is transitioned from the sleep state to the awake state. The ML PS-Poll frame transmitted in the first link may include information indicating whether the STA MLD can receive a data frame in another link, information indicating the state (e.g., operation state) of the STA in each link, and/or information indicating a sensing result for a preset time in another link. When the STA MLD does not receive a data frame in another link, a sensing result for the preset time may be configured to indicate a busy state.

When the STA associated with the AID is the STA MLD, the ML PS-Poll frame may be configured by interpreting a receiver address (RA) and/or a transmitter address (TA) of the existing PS-Poll frame into another form. An additional format of the ML PS-Poll frame may be configured. When the ML PS-Poll frame is configured by interpreting the RA and/or TA of the PS-Poll frame in another form, an available link bitmap may indicate link(s) in an active state, and a link status bitmap may indicate a sensing result for a preset time (e.g., SIFS, PIFS, or NAV synchronization time). When the additional format of the ML PS-Poll frame is used, the link(s) in the active state may be indicated by the AID(s) and/or the MAC address(s) of the STA(s), and the link status bitmap may indicate a sensing result for the preset time.

The ML PS-Poll frame may be transmitted in a link capable of transmitting the ML PS-Poll frame first among multiple links. For example, when the first link and the third link are indicated by the beacon frame and when the ML PS-Poll frame can be transmitted in the third link in the idle state after an AIFS, NAV synchronization (NAVSyncDelay) time, or (NAV synchronization time+SIFS) elapses, the ML PS-Poll frame may be transmitted in the third link. When the ML PS-Poll frame is transmitted in the link capable of transmitting the ML PS-Poll frame first among multiple links, a probability that the state(s) of other link(s) are the busy state may be high.

When the ML PS-Poll frame is transmitted in the link capable of transmitting the ML PS-Poll frame first among the multiple links, the ML PS-Poll frame may indicate only that the STA MLD (e.g., at least one STA among the STAs of the STA MLD) transitioned to the awake state, and the ML PS-Poll frame may not indicate a link state when the execution time of the channel sensing operation is not sufficient. Accordingly, the state information of each link may be transmitted through a separate frame in each link. When the channel access operation is successful, the STA1 may notify that the first link is available by transmitting a clear-to-send (CTS) frame in the first link. An RA of the CTS frame may be set to the MAC address of the STA1. In other words, the CTS frame may be a CTS-to-self frame. When the CTS-to-self frame is received from the STA1 (e.g., STA performing a low-power operation in the multi-link), the AP MLD may notify that the corresponding link (e.g., the link in which the CTS-to-self frame is received) is in a reception state and may transmit a data frame after a preset time (e.g., SIFS).

The STA1 may transmit a trigger frame to the AP MLD (e.g., AP1) instead of the CTS-to-self frame. A receiver of the trigger frame may be set to the AP MLD. A value of a duration field included in a MAC header of the CTS-to-self frame or the trigger frame may be set to the maximum value configurable by the STA MLD. A transmit opportunity (TXOP) may be configured based on the value of the above-described duration field. A duration field included in a MAC header of a subsequently-transmitted data frame may be set to a duration required for transmission of the data frame and an ACK frame therefor. After reception of the beacon frame (e.g., TIM), the CTS-to-self frame or trigger frame may be transmitted instead of the ML PS-Poll frame in a link capable of transmitting the CTS-to-self frame or trigger frame first among the multiple links. After transmission of the ML PS-Poll frame, the CTS-to-self frame, or the trigger frame, a data frame transmission/reception procedure may be performed between the AP1 and the STA1.

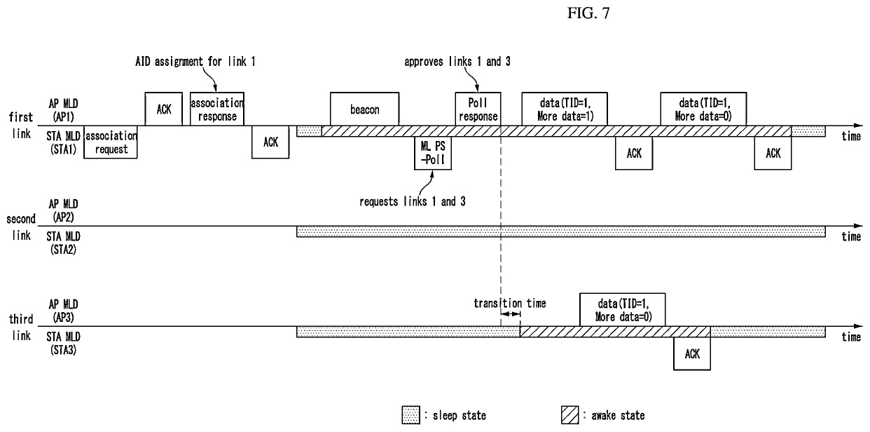

FIG. 7 is a timing diagram illustrating a fourth embodiment of a communication method based on a low-power operation in a wireless LAN system.

As shown in FIG. 7, a communication node may transmit/receive frames using a plurality of links (e.g., first link, second link, and third link). In embodiments, the communication node may be an AP MLD, an AP affiliated with an AP MLD, a STA MLD (e.g., non-AP MLD), or a STA affiliated with a STA MLD. The device (e.g., AP MLD and/or non-AP MLD) may use different MAC addresses for the respective links. Although the device is one communication node, the device may act like a different communication node in each of the links. For example, a first AP affiliated with the AP MLD may operate in the first link, a second AP affiliated with the AP MLD may operate in the second link, and a third AP affiliated with the AP MLD may operate in the third link. A first STA affiliated with the STA MLD may operate in the first link, a second STA affiliated with the STA MLD may operate in the second link, and a third STA affiliated with the STA MLD may operate in the third link.

The STA MLD (e.g., first STA) may perform an access procedure with the AP MLD (e.g., first AP) in the first link. By exchanging an association request frame and an association response frame in the access procedure, basic function(s) between the STA MLD and the AP MLD may be agreed upon (e.g., negotiated). In this case, parameter(s) for low-power operations may be negotiated. The association request frame may include a listen interval field, and the listen interval field may indicate a transmission interval of a beacon frame (e.g., beacon frame including a TIM). A period indicated by the listen interval field may refer to a period in which a reception operation is performed for a low-power operation. A period other than the period indicated by the listen interval field may refer to a period in which a reception operation is not performed. The listen interval field set to 0 may indicate that a low-power operation is not performed.

The low-power operation may be an operation of receiving a TIM indicating whether a BU exists in a link (e.g., first link) where the association request frame is transmitted/received. When desiring to receive the TIM in another link, information indicating the corresponding link may be included in the association request frame. The AP MLD may receive the association request frame from the STA MLD in the first link and may identify information element(s) (e.g., listen interval field) included in the association request frame. The AP MLD may transmit an ACK frame for the association request frame to the STA MLD. Alternatively, transmission of the ACK frame for the association request frame may be omitted.

The AP MLD may set an AID to be used by the STA. The AID may be set for each link. The AP MLD may transmit an association response frame including the AID of each of the links. The AID may be used to indicate (e.g., identify) a communication node (e.g., STA) in the case(s) below.
Case 1: When the AP allocates a resource to a communication node (e.g., STA) using a trigger frame
Case 2: When the AP uses a TIM to indicate a communication node to receive a BU
Case 3: When the communication node transmits a PS-Poll frame to receive a BU indicated by a TIM

Even when the STA MLD supports the multi-link, if the ML PS-Poll frame is transmitted in one link, it may not be necessary to assign a distinct AID for each link. For example, ‘AID=1111’ may be assigned only to the STA1 of the STA MLD. The STA2 and STA3 operating in different links may have the same AID (e.g., 1111) as the STA1. Each of the links (e.g., STAs affiliated with the STA MLD) may be identified by link identification information (e.g., link identifiers or traffic IDs (TIDs)). The AP MLD and the STA MLD may perform a negotiation procedure of mapping links to receive to traffic IDs (TIDs) of data frames to be received (i.e., TID-to-link mapping). After the negotiation procedure is performed, the communication node (e.g., AP MLD, STA MLD, AP, STA) may determine the links to receive based on the mapping relationship between the TIDs and the links when the TIDs of the data frames to be received are known.

When the access procedure is terminated, the STA MLD may perform a low-power operation. For example, the STA1 may perform a low-power operation in the first link (e.g., link where the access procedure has been performed), and the STA2 and/or STA3 may perform low-power operations in other links (e.g., the second link and/or the third link) as well as the first link. The STA1 may operate in the sleep state in the first link and may transition to the awake state at a time negotiated in the access procedure.

The STA MLD (e.g., STA1) operating in the awake state may perform a reception operation of a beacon frame and may identify a TIM included in the beacon frame. When the TIM indicates that a BU for the STA MLD does not exist, the operation state of the STA MLD may transition from the awake state to the sleep state. In other words, the STA MLD may operate in the sleep state. When the TIM indicates that a BU for the STA MLD exists, the STA (e.g., STA1) of the STA MLD may operate in the awake state without transitioning to the sleep state. In other words, the operation state of the STA1 may be maintained in the awake state.

The STA1 of the STA MLD may receive the frame (e.g., beacon frame (e.g., TIM)) including link identification information (e.g., TIDs and/or link identifiers) of links in which BUs are to be received, and an ML PS-Poll frame including information indicating link(s) in which the STA MLD can receive data frame(s) (e.g., links in which the data frame(s) can be received), among the links indicated by the link identification information, may be transmitted in the first link. For example, the ML PS-Poll frame may indicate the first link and the third link. In other words, the ML PS-Poll frame may request use of the first link and the third link. The AP1 may receive the ML PS-Poll frame from the STA1 and may identify that use of the first link and the third link is requested based on the ML PS-Poll frame. The AP1 may approve (e.g., allow) the use of the link(s) requested by the STA1 when predefined condition(s) are satisfied. When the use of the link(s) is approved, the AP1 may transmit a response frame to the ML PS-Poll frame (hereinafter, referred to as ‘Poll response frame’) to the STA1 in the first link. When the Poll response frame is received from the AP1, the STA1 may determine that the data frames are to be transmitted in the first link and the third link. In other words, the Poll response frame may indicate that the use of the first link and the third link is approved. When the size of data to be transmitted is not large and transmission of the data in one link is possible, the AP1 may reject all or part of the use of the first link and the third link requested by the STA MLD. When the AP1 rejects use of all the links requested by the STA MLD, the AP1 may not transmit the Poll response frame to the STA1. Alternatively, when indicating that only one link is approved, the AP1 may transmit the Poll response frame indicating only one link to the STA1. In this example, the Poll response frame may include information (e.g., link number) indicating the link approved by the APE

When the Poll response frame is received from the AP MLD, the STA MLD may transition the negotiated link (e.g., the third link) to the active state. For example, the operation state of the STA3 operating in the third link may be transitioned from the sleep state to the awake state. The AP MLD may transmit a data frame in the third link after the awake transition time elapses from a transmission time of the Poll response frame. In this example, the awake transition time may be a time required for the STA MLD to activate the third link or a time required for the operation state of the STA3 to transition from the sleep state to the awake state. Since the first link is still in the active state, when the channel access procedure is successful, the AP1 may transmit a data frame in the first link. Even when the ML PS-Poll frame transmitted by the STA MLD requests only the use of the first link, the AP MLD may indicate to use the third link as well as the first link through the Poll response frame.

In order to reduce the transition time, the STA MLD may transition the link(s) indicated to use (e.g., link(s) desired to use) at the transmission time of the ML PS-Poll frame or at a time earlier than the corresponding transmission time to the active state. The transitioning of the link(s) to the active state may mean transitioning of the operation state of the STA(s) operating in the corresponding link(s) from the sleep state to the awake state. The transitioning of the link(s) to the idle state may mean transitioning the operation state of the STA(s) operating in the corresponding link(s) from the awake state to the sleep state. When the request to use a specific link is rejected by the AP MLD, the STA MLD may transition the specific link to the idle state. Since the link is already active at the time of transmitting the Poll Response frame, the AP MLD may transmit a data frame in the corresponding link when the channel access procedure is successful after transmitting the Poll Response frame.

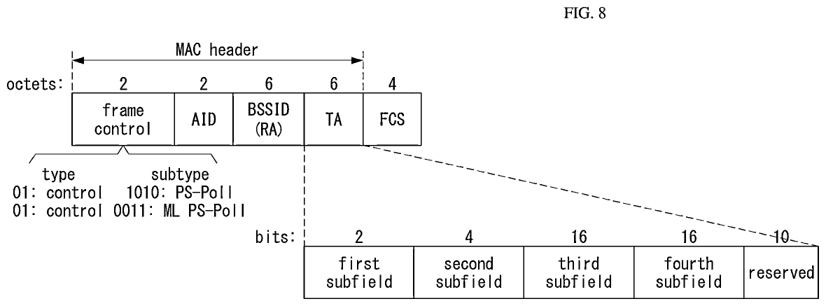

FIG. 8 is a block diagram illustrating a first embodiment of a PS-Poll frame in a wireless LAN system supporting a multi-link.

As shown in FIG. 8, when a beacon frame (e.g., TIM included in the beacon frame) indicates that data (e.g., BU) to be transmitted to the STA MLD exists, the STA MLD may transmit a PS-Poll frame. The PS-Poll frame may be transmitted in a link where the TIM is received and/or in a link where the data indicated by the TIM is to be received. When an AID field of the PS-Poll frame is set to an AID corresponding to the link where the TIM is received or when only one AID is assigned to the STA MLD and thus all STAs of the STA MLD have the same AID and when the AP MLD indicates that the AP MLD is to transmit data frames through multiple links by using link identification information of the links to receive the data frames, a TA field and/or RA field having a size of 6 bytes may be interpreted as multi-link information field(s). When the AID field of the PS-Poll frame is set to the AID of the STA MLD, the TA field may include at least one of a first subfield indicating STR capability of the STA MLD (e.g., STA affiliated with the STA MLD), a second subfield indicating the number of links of the STA MLD, a third subfield indicating an available link bitmap, a fourth subfield indicating a link status bitmap, a reserved subfield, or combinations thereof. The size of the first subfield may be 2 bits, the size of the second subfield may be 4 bits, the size of the third subfield may be 16 bits, the size of the fourth subfield may be 16 bits, and the size of the reserved subfield may be 10 bits. The third subfield and the fourth subfield may have variable lengths according to a value indicated by the second subfield. For example, when the number of links indicated by the second subfield is 3 (e.g., when the second subfield is set to 00011), the length of each of the third subfield and the fourth subfield may be 3 bits.

The first subfield (e.g., STR capability) set to 00 may indicate that STR operations are possible. The first subfield set to 01 may indicate that STR operations are impossible. The first subfield set to 10 may indicate that conditional STR operations are not possible. The first subfield set to 11 may be reserved bits. That the conditional STR operations are impossible may mean that there is a link in which STR operations are impossible due to in-device coexistence (IDC) interference according to a combination of links.

The second subfield may indicate the total number of links supportable by the STA MLD. The second subfield set to 1111 may indicate that 16 links are supportable. The second subfield set to 0001 may indicate that link(s) other than the link where the PS-Poll frame is currently transmitted are not available. The second subfield set to 0011 may indicate that 3 links are supportable.

When the maximum number of supportable links exceeds 16, the number of bits of the second subfield and/or the third subfield may be increased. The third subfield (e.g., available link bitmap) may indicate available link(s) among the links supported by the STA MLD. For example, the third subfield set to [1011 0000 0000 0000] may indicate that the first link, the third link, and the fourth link are available.

The fourth subfield (e.g., link status bitmap) may indicate link(s) that are idle for a preset time (e.g., SIFS, PIFS, or NAVSyncDelay time). For example, a combination of the third subfield set to [1011 0000 0000 0000] and the fourth subfield set to [1001 0000 0000 0000] may indicate that the available third link is occupied by another communication node.

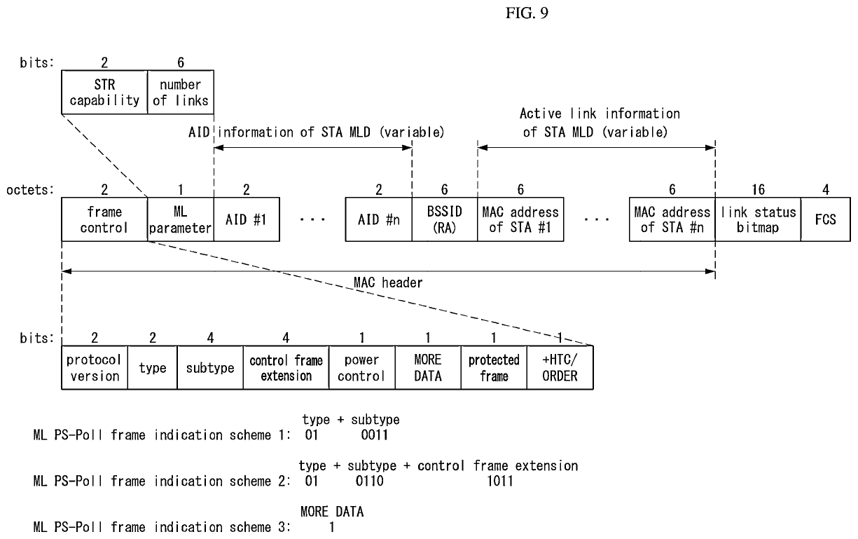

FIG. 9 is a block diagram illustrating a first embodiment of an ML PS-Poll frame in a wireless LAN system supporting a multi-link.

As shown in FIG. 9, when a beacon frame (e.g., TIM included in the beacon frame) indicates that data (e.g., BU) to be transmitted to the STA MLD exists, the STA MLD may transmit an ML PS-Poll frame. The ML PS-Poll frame may be transmitted in a link where the TIM has been received and/or a link where the data is to be received, which is indicated by link identification information (e.g., TIDs and/or link identifiers) (e.g., TIM). Alternatively, the ML PS-Poll frame may be transmitted in a link where a channel access procedure is first successful among links to receive the data indicated by the link identification information of the links to be received. The ML PS-Poll message distinct from the PS-Poll message may be indicated based on the following schemes.

As a first scheme, a type field may be set to 01 indicating a control frame, and a subtype field may be set to 0011 indicating the ML PS-Poll frame. As a second scheme, the type field may be set to 01 indicating a control frame, the subtype field may be set to 0110 indicating a control frame extension, and a control frame extension field may be set to 1011 indicating the ML PS-Poll frame. As a third scheme, the ML PS-Poll frame may be indicated by setting a more data field to 1. The more data field set to 0 may indicate the PS-Poll frame.

The ML PS-Poll frame may include an ML parameter field. The ML parameter field may have a size of 8 bits and may include one or more among a subfield indicating STR capability (e.g., the first subfield shown in FIG. 7) and a subfile indicating the number of links (or the number of AIDs) (e.g., the second subfield shown in FIG. 7). In addition, the ML PS-Poll frame may further include an AID for each link and/or a MAC address of a STA for each link and/or a link bitmap. The number of AIDs or MAC addresses included in the ML PS-Poll frame may be the same as the number of AIDs or links indicated by the ML parameter field.

A different AID may be assigned to each link (e.g., STA) associated with the same STA MLD. In this case, AIDs as many as the number of links associated with the same STA MLD may be included in the ML PS-Poll frame, and the AIDs included in the ML PS-Poll frame may indicate available links. When different AIDs are not assigned for the respective links, MAC addresses as many as the number of links associated with the same STA MLD may be included in the ML PS-Poll frame, and the MAC addresses included in the ML PS-Poll frame indicate available links. The link status bitmap field may indicate link(s) that are idle for a preset time (e.g., SIFS) or link(s) desired to receive data frame(s).

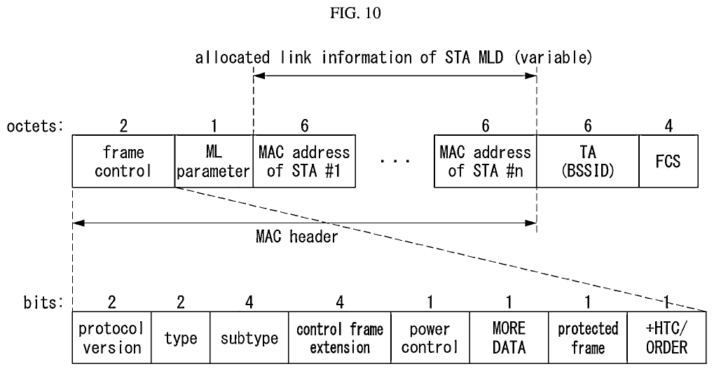

FIG. 10 is a block diagram illustrating a first embodiment of a Poll response frame in a wireless LAN system supporting a multi-link.

As shown in FIG. 10, when a beacon frame (e.g., TIM included in the beacon frame) indicates that data (e.g., BU) to be transmitted to the STA MLD exists, the STA MLD may transmit an ML PS-Poll frame. The AP MLD may receive the ML PS-Poll frame from the STA MLD and may transmit a response frame (i.e., Poll response frame) to the ML PS-Poll frame to the STA MLD. The Poll response message may be indicated based on the schemes below. As a first scheme, a subtype field may be set to a new value indicating the Poll response frame. For example, values of a type field and the subtype field may be set to indicate the Poll response frame. As a second scheme, the subtype field may be set to 0110 indicating a control frame extension, and a control frame extension field may be set to a new value indicating the Poll response frame.

The Poll response frame may include an ML parameter field, and the ML parameter field may indicate the number of links. MAC addresses of STAs as many as the number of links indicated by the ML parameter field may be included in the Poll response frame. The MAC addresses included in the Poll response frame may be associated with the links. In other words, the MAC addresses included in the Poll response frame may indicate links used by the STA MLD. The AP MLD and/or the STA MLD may finally determine links to be used based on the link information (e.g., the number of links and/or MAC addresses) included in the Poll response frame.

The embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those having ordinary skill in the art.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1-20. (canceled)

21. A method of a first multi-link device (MLD), the method comprising:
transitioning, by a first station (STA) affiliated with the first MLD, an operating state of the first STA from a sleep state to an awake state in a first link;
receiving, by the first STA, a beacon frame from a first access point (AP) affiliated with a second MLD in the first link;
when the beacon frame indicates that a data frame to be transmitted in the first link exists, transmitting, by the first STA, a first power saving (PS)-Poll frame to the first AP in the first link; and
performing, by the first STA, a transmission and reception operation of the data frame with the first AP in the first link after transmitting the first PS-Poll frame.

22. The method according to claim 21, wherein the beacon frame includes first information indicating one or more links in which the data frame is transmitted.

23. The method according to claim 22, wherein the first information is an indicator indicating each of the one or more links or an association identifier (AID) associated with each of the one or more links.

24. The method according to claim 23, wherein the AID is configured in a setup procedure between the first MLD and the second MLD.

25. The method according to claim 22, further comprising:
when the first information indicates the first and second links, transmitting, by a second STA affiliated with the first MLD, a second PS-Poll frame to a second AP affiliated with the second MLD in the second link.

26. The method according to claim 21, wherein, when the beacon frame indicates that the data frame to be transmitted in the first link, the operating state of the first STA is maintained in the awake state.

27. A first multi-link device (MLD), comprising:
a processor, wherein the processor causes the first MLD to
transition, by a first station (STA) affiliated with the first MLD, an operating state of the first STA from a sleep state to an awake state in a first link,
receive, by the first STA, a beacon frame from a first access point (AP) affiliated with a second MLD in the first link,
when the beacon frame indicates that a data frame to be transmitted in the first link exists, transmit, by the first STA, a first power saving (PS)-Poll frame to the first AP in the first link, and
perform, by the first STA, a transmission and reception operation of the data frame with the first AP in the first link after transmitting the first PS-Poll frame.

28. The first MLD according to claim 27, wherein the beacon frame includes first information indicating one or more links in which the data frame is transmitted.

29. The first MLD according to claim 28, wherein the first information is an indicator indicating each of the one or more links or an association identifier (AID) associated with each of the one or more links.

30. The first MLD according to claim 29, wherein the AID is configured in a setup procedure between the first MLD and the second MLD.

31. The first MLD according to claim 28, wherein the processor further causes the first MLD to:
when the first information indicates the first and second links, transmit, by a second STA affiliated with the first MLD, a second PS-Poll frame to a second AP affiliated with the second MLD in the second link.

32. The first MLD according to claim 27, wherein, when the beacon frame indicates that the data frame to be transmitted in the first link, the operating state of the first STA is maintained in the awake state.
